(19) United States
(12) Patent Application Publication
(10) Pub. No.: US 2006/0060215 A1
(43) Pub. Date: Mar. 23, 2006

(54) Dishwasher and method for controlling the same

(76) Inventor: Yong Jae Lee, Changwon-si (KR)

Correspondence Address: MCKENNA LONG & ALDRIDGE LLP;Song K. Jung, 1900 K Street, N.W., Washington, DC, 20006, US

(21) Appl. No.: 11/190,916

(22) Filed: Jul. 28, 2005

(30) Foreign Application Priority Data
Sep. 17, 2004 (KR) 10-2004-0074347

(51) Int. Cl. B08B 7/04; B08B 9/20; B08B 3/00; B08B 3/12

(52) U.S. Cl. 134/18; 134/56 D; 134/172; 134/25.2

(57) ABSTRACT

Dishwasher including a water level sensing unit for sensing change of a water level of washing water during progressing washing, and a control unit for determining whether an error is occurred or not in washing water spray according to a water level sensed at the water level sensing unit, thereby sensing the water level during washing, to detect stuck of the spray nozzle, or fall off of the water guide and inform to the user, to enable the user to control a process thereafter selectively, permitting to improve a washing performance.

### BACKGROUND OF THE INVENTION

1. Field of the Invention

The present invention relates to dishwashers, and more particularly, to a dishwasher, and a method for controlling the same, in which faults at a nozzle or a washing water flow passage is detected during washing of the dishwasher, for improving a washing performance.

2. Discussion of the Related Art

In general, the dishwasher sprays washing water to an upper rack and a lower rack, to wash dishes on the racks.

FIG. 1 illustrates a perspective view of a related art dishwasher, and FIG. 2 illustrates a section of an elevation of a related art dishwasher.

In general, the dishwasher 10 is provided with a tub 11 having a dishwashing cavity formed therein, a door 12 on a front of the tub for opening/closing the washing cavity, and a sump 13 in a central portion of under the tub 11 for holding washing water.

The dishwasher is also provided with a washing pump 14 connected to the sump 13 for pumping up the washing water from the sump 13 at a high pressure, and a motor 15 attached on a rear surface of the washing pump 14 for driving the washing pump 14.

The dishwasher is also provided with a water guide 16 which is a flow passage of the pumped washing water, a lower nozzle 17 over the sump 13 at a lower portion of the washing cavity for spraying washing water upwardly, an upper nozzle 18 attached to an upper portion of the water guide 16 and extended from the water guide 16 perpendicular thereto to position at the middle of the washing cavity, and a top nozzle 19 close to a ceiling of the tub for spraying washing water, downwardly.

The dishwasher is also provided with an upper rack 20 mounted over the upper nozzle 18 for washing dishes therein with the upper nozzle 18, and a lower rack 21 over the lower nozzle 17 for washing dishes therein with the lower nozzle 17.

In more detail, the upper rack 20 is supported on rails (not shown) mounted on inside surfaces of the tub 11 for moving back and forth thereon.

With regard to the dishwasher 10, the user opens the door 12 of the dishwasher, pulls the upper rack 20 and the lower rack 21 to an outside of the washing cavity.

Then, after placing dishes on the upper rack 20 and the lower rack 21, the door 12 is closed, and power is applied thereto, to put the dishwasher into operation.

In the meantime, if power is applied to the dishwasher, to perform a washing step, washing water is introduced into the sump 13, and, if the introduction step is finished, the motor 15 is operated.

Then, as the impeller (not shown) in the washing pump 14 connected to the motor 15 with a shaft is rotated, washing water is pumped to the lower nozzle 17 and the water guide 16.

The washing water pumped to the water guide 16 moves to the top nozzle 19 and the upper nozzle 18, and sprayed into the washing cavity, to wash the dishes on the upper rack 20 and the lower rack 21.

In this instance, the top nozzle 19 sprays washing water downwardly, and the upper nozzle 18 sprays washing water upwardly, to wash dishes on the upper rack 20.

The related art dishwasher can fail in spraying of washing water regularly as the upper nozzle and/or lower nozzle is stuck, or clogged with large sized food remnants separated from the dishes in the dish washing step.

If spray of washing water fails thus, the upper nozzle and/or the lower nozzle can not rotate regularly, to impair washing performance of the dishwasher, to cause problems of increases washing time period and power consumption. However, there is no way for the user to detect this.

Therefore, since operation of the dishwasher is continued in a state above problem is not solved, user's satisfaction, and reliability on the dishwasher drops.

Moreover, even in a case of fault of the flow passage, such as fall off of the water guide, which is a moving passage of the washing water, regular circulation of the washing water fails, to impair the washing performance of the dishwasher, to prolong a washing time period, and increase power consumption. However, there is no way for the user to detect this.

Therefore, since operation of the dishwasher is continued in a state above problem is not solved, user's satisfaction, and reliability on the dishwasher drops.

### SUMMARY OF THE INVENTION

Accordingly, the present invention is directed to a dishwasher, and a method for controlling the same that substantially obviates one or more problems due to limitations and disadvantages of the related art.

An object of the present invention is to provide a dishwasher, and a method for controlling the same, in which faulty nozzle and/or faulty washing water flow passage is detected during washing of a dishwasher, for improving a washing performance.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher having spray nozzles for spraying washing water to wash dishes includes a water level sensing unit for sensing change of a water level of washing water during progressing washing, and a control unit for determining whether an error is occurred or not in washing water spray according to a water level sensed at the water level sensing unit, wherein the dishwasher provides a message for warning occurrence of the error in washing water spray to a user.

Causes of error occurrence are classified as either stuck of the spray nozzle, or fall off of a water guide which is a washing water circulating passage according to the water level sensed.

The water level sensed at the time of fall off of the water guide which is a circulating passage of the washing water is higher than the water level sensed at the time of stuck of the spray nozzle.

The dishwasher further includes a display unit for displaying occurrence of the error and a cause of the error, and an alarm generating unit for providing an alarm.

In another aspect of the present invention, a method for controlling a dishwasher having spray nozzles for spraying washing water to wash dishes, includes the steps of sensing change of a water level of washing water while progressing washing with reference to a preset course, comparing the water level sensed to a preset reference value to determine whether spray of washing water is regular or not, and giving a warning to a user if it is determined that the spray of washing water is not regular.

Preferably, the change of a water level of washing water is sensed with reference to a water level of a tub in which the washing water circulated is held.

The step of comparing the water level sensed to a preset reference value includes the step of determining that the spray nozzle for spraying washing water is faulty if the sensed water level is higher than the preset reference water level.

The step of comparing the water level sensed to a preset reference value includes the step of determining that a water guide which is a circulating flow passage of the washing water is faulty if the sensed water level is higher than the preset reference water level.

The step of comparing the water level sensed to a preset reference value includes the steps of comparing the sensed water level to a preset first reference value, to determine that the washing water spray is not regular if the sensed water level is higher than the first reference value, and comparing the sensed water level to a preset second reference value again, to determine a cause of the washing water spray error according to a result of the comparison.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view of a related art dishwasher;

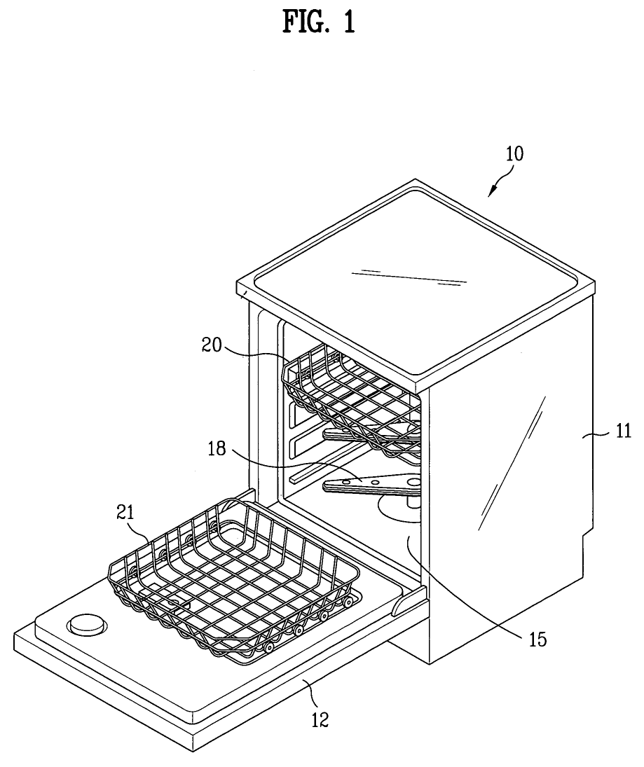

FIG. 2 illustrates a section of an elevation of a related art dishwasher;

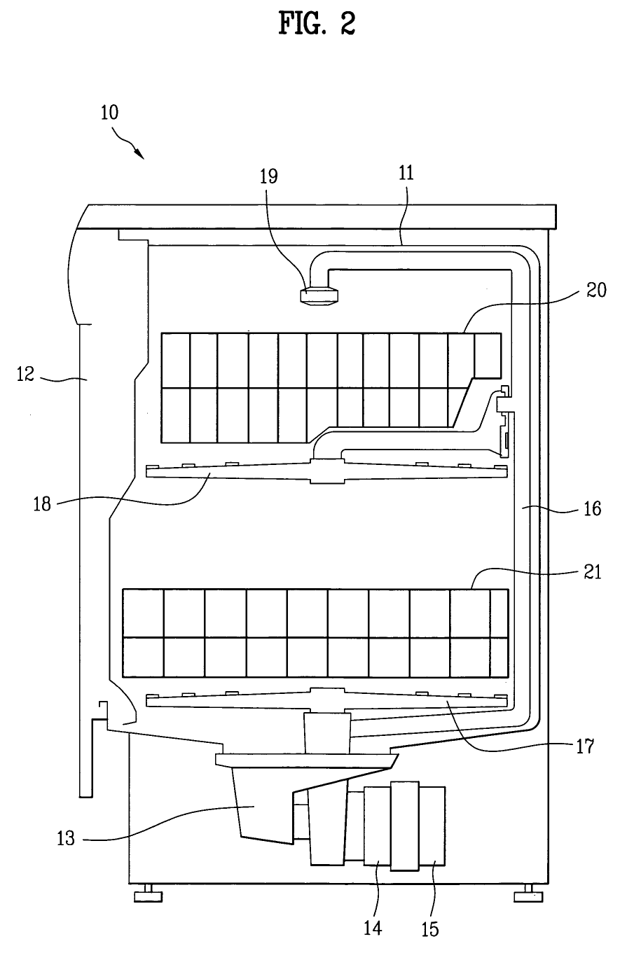

FIG. 3 illustrates a block diagram of a dishwasher in accordance with a preferred embodiment of the present invention;

FIG. 4 illustrates a flow chart showing the steps of a method for controlling a dishwasher in accordance with a first preferred embodiment of the present invention;

FIG. 5 illustrates a flow chart showing the steps of a method for controlling a dishwasher in accordance with a second preferred embodiment of the present invention; and

FIG. 6 illustrates a flow chart showing the steps of a method for controlling a dishwasher in accordance with a third preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

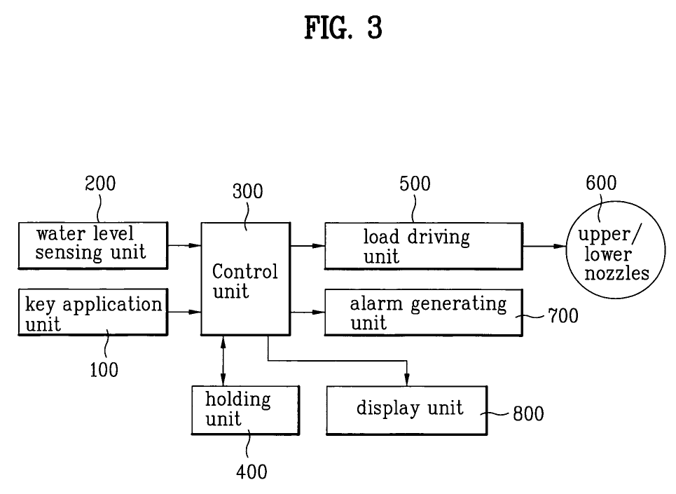

FIG. 3 illustrates a block diagram of a dishwasher in accordance with a preferred embodiment of the present invention.

The present invention suggests sensing a water level in a tub, to give a warning that an error of washing water spray is occurred in a case the water level exceeds a regular range, for solving the problem of washing performance drop due to non-regular washing water circulation caused by stuck of the nozzle or fall off of the water guide.

The dishwasher of the present invention utilizes an increase of water quantity in the tub in a case the washing water is not sprayed regularly due to stuck nozzle and/or fall off of a water guide, and includes water level sensing means for sensing a water level of washing water.

Moreover, the dishwasher of the present invention also includes control means for determining whether the dishwasher is operated regularly at the present time, or the dishwasher is in a state that a fault is occurred in a washing water moving passage due to stuck nozzle, and/or fall off of the water guide.

In more detail, referring to FIG. 3, the control means includes a key application unit 100, a water level sensing unit 200 for sensing a water level of washing water, a controlling unit 300, if the user selects a desired washing course and applies an operation order through the key application unit, for controlling to make a required washing course done, determining a faulty nozzle, such as stuck of upper/lower nozzles, and/or a faulty washing water moving passage, such as fall off of the water guide, and the like according to the water level sensed at the water level sensing unit 200 during washing, and providing a relevant control signal, a load driving unit 500 for controlling driving of a load, an alarm generating unit 700 and a display unit 800 for indicating a non-regular state of the upper/lower nozzles and/or the water guide in response to a control signal from the controlling unit 300, and a storing unit 400 for storing various menus and control values required for setting a washing course, and progressing.

The operation of the dishwasher of the present invention will be described.

If the user applies a power on order through the key application unit 100, and applies an operation order after selection of a desired washing course, the control unit 300 provides a control order to the load driving unit 500 so that the selected washing course is performed.

The water level sensing unit 200 senses a water level in the tub at the same time with starting of the washing operation.

If it is determined from the sensed water level that water is held in the tub due to failure of regular rotation of the upper/lower nozzles 600 come from clogged, or interference of nozzle with foreign matters, or non-regular spray of washing water come from fall off of the water guide, or the like, the control unit 300 indicates an error state by the alarm generating unit 700 and on the display unit 800.

While it is determined that an error is occurred in a case the water level in the tub exceeds a regular range, since more water is held in fall off of the water guide than a fault is occurred at the nozzle, a reference water level is set for classifying causes of error occurrences according to capacities of the dishwasher.

Error states can be classified, and indicated as an error from the nozzle, and an error from the water guide, and the alarms also can be provided different from each other according to causes of the errors.

A method for controlling a dishwasher in accordance with a preferred embodiment of the present invention will be described.

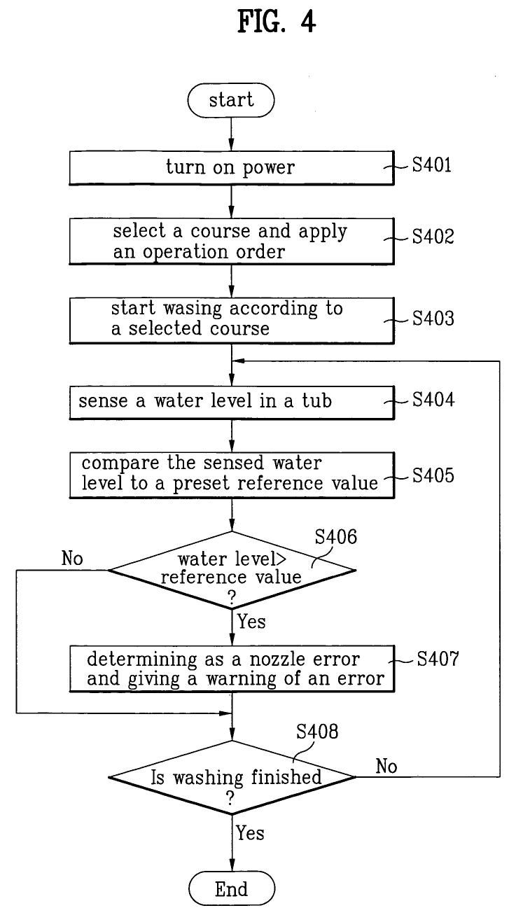

FIG. 4 illustrates a flow chart showing the steps of a method for controlling a dishwasher in accordance with a first preferred embodiment of the present invention.

The dishwasher control in accordance with a first preferred embodiment of the present invention suggests determining that washing water spray is not regular due to clogged, or interference of nozzle with foreign matters in a case a water level in a tub exceeds a regular range, and informing this to the user, so that the user can take an appropriate measure.

At first, power to the dishwasher is turned on (S401), and a course for washing dish is selected, and an operation order is applied. (S402)

When the user applies the operation order, the dishwasher starts to wash according to a selected course. (S403)

While performing washing, the washing water level held in the tub is sensed. (S404).

The sensed water level is compared to a preset reference value (S405), to continue the set washing course while sensing the water level if the sensed water level is low. (S406).

The reference value may vary with capacities of dishwashers, and selected washing courses, and is required to set to a value that can classifies a regular range, and a non-regular range of washing water spray.

If the sensed water level is higher than the preset reference value (S406), the control unit determines that the washing water spray is not regular due to clogged, or interference of nozzle with foreign matters, and gives alarm to the user that an error is occurred. (S407).

The error message to the user includes display of characters (or a symbol) for informing that the nozzle is in trouble, or generation of an alarm.

The error message may continue until a preset time, or the user takes an appropriate measure.

If all washing steps are finished by progressing washing including the water level sensing, the comparison to the reference value, and an alarming algorithm according to a result, the washing is terminated. (S408).

The dishwasher control method in accordance with a first preferred embodiment of the present invention gives alarm to the user that an error is occurred by utilizing that an amount of water held in the tub becomes greater in a case washing water is sprayed non-regularly due to nozzle error than in a case the nozzle rotates regularly.

Accordingly, the continuous operation of the dishwasher failing to notice an error occurrence can be prevented.

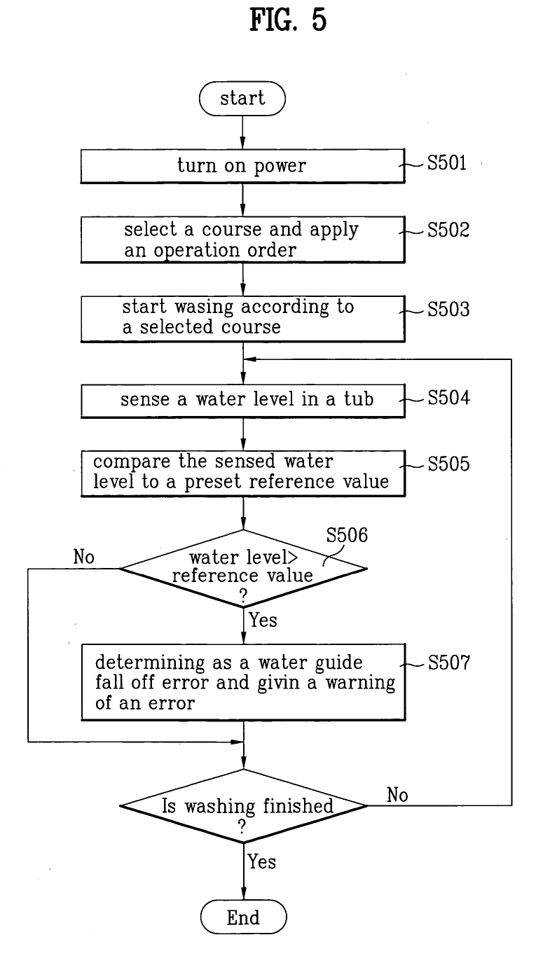

FIG. 5 illustrates a flow chart showing the steps of a method for controlling a dishwasher in accordance with a second preferred embodiment of the present invention.

The dishwasher control in accordance with a second preferred embodiment of the present invention suggests determining that washing water spray is not regular due to fall off of a water guide which is a washing water circulating path, or the like in a case a water level in a tub exceeds a regular range, and informing this to the user, so that the user can take an appropriate measure.

At first, power to the dishwasher is turned on (S501), and a course for washing dish is selected, and an operation order is applied. (S502)

When the user applies the operation order, the dishwasher starts to wash according to a selected course. (S503)

While performing washing thus, the washing water level held in the tub is sensed. (S504).

The sensed water level is compared to a preset reference value (S505), to continue the set washing course until the washing course is finished while sensing the water level if the sensed water level is low. (S506).

The reference value may vary with capacities of dishwashers, and selected washing courses, and is required to set to a value that can classifies a regular range, and a non-regular range of washing water spray.

The reference values in the first, and second preferred embodiments may be set different from each other.

If the sensed water level is higher than the preset reference value (S506), the control unit determines that the washing water spray is not regular due to fall off of a water guide which is a washing water circulating path, or the like, and gives alarm to the user that an error is occurred. (S507).

The error message to the user includes display of characters (or a symbol), or generation of an alarm, for informing that the water guide is in trouble.

The error message may continue until a preset time, or the user takes an appropriate measure.

If all washing steps are finished by progressing washing including the water level sensing, the comparison to the reference value, and an alarming algorithm according to a result, the washing is terminated. (S508).

The dishwasher control method in accordance with a second preferred embodiment of the present invention gives alarm to the user that an error is occurred by utilizing that an amount of water held in the tub becomes greater in a case washing water is sprayed non-regularly due to faulty water guide.

Accordingly, the continuous operation of the dishwasher failing to notice an error occurrence can be prevented.

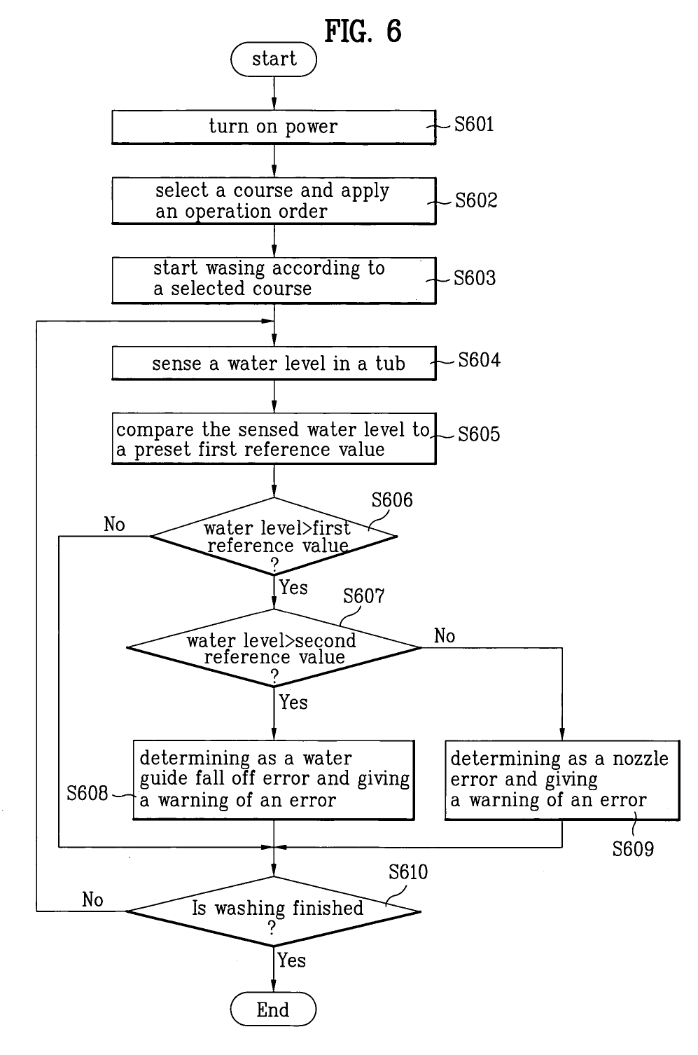

FIG. 6 illustrates a flow chart showing the steps of a method for controlling a dishwasher in accordance with a third preferred embodiment of the present invention.

The dishwasher control in accordance with a third preferred embodiment of the present invention suggests comparison of a sensed water level to a first reference value to determine that washing water spray is not regular if the water level in a tub exceeds a regular range.

Then, the sensed water level is compared to a preset second reference value again, to determine a cause of the non-regular washing water spray, and this is informed to the user, so that the user can take an appropriate measure.

At first, power to the dishwasher is turned on (S601), and a course for washing dish is selected, and an operation order is applied. (S602)

When the user applies the operation order, the dishwasher starts to wash according to a selected course. (S603)

While performing washing thus, the washing water level held in the tub is sensed. (S604).

The sensed water level is compared to the first preset reference value (S605), to continue the set washing course until the washing course is finished while sensing the water level if the sensed water level is low. (S606).

The first reference value may vary with capacities of dishwashers, and selected washing courses, and is required to set to a value that can classifies a regular range, and a non-regular range of washing water spray.

If the sensed water level is higher than the first preset reference value (S606), the control unit compares the sensed water level to the second reference value again for determining a cause of the error occurrence (S607).

The first reference value is set to a value lower than the second reference value, wherein it is determined that the dishwasher is under a regular operation if the sensed water level is lower than the first reference value, has trouble in the spray nozzle if the sensed water level is in a range between the first reference value and the second reference value, and has trouble in the water guide if the sensed water level is higher than the second reference value.

This is utilization of a phenomenon in which more washing water is held in the tub in a case the water guide is in trouble than in a case the spray nozzle is in trouble.

If the sensed water level is higher than the second reference value, the control unit determines that the non-regular spray of washing water is caused by fall off of the water guide or the like, informs this to the user with an alarm that an error is occurred, so that the user can take an appropriate measure.

If the sensed water level is not higher than the second reference value, the control unit determines that the non-regular spray of washing water is caused by clogged, or interference of the nozzle with foreign matters, and give alarm to the user that an error is occurred. (S609).

The error message to the user includes display of characters (or a symbol), or generation of an alarm, for informing that the spray nozzle, or the water guide is in trouble.

The error message may continue until a preset time, or the user takes an appropriate measure.

If all washing steps are finished by progressing washing including the water level sensing, the comparison to the first, and second reference values, and an alarming algorithm according to the result, the washing is terminated. (S610).

The dishwasher control method in accordance with a third preferred embodiment of the present invention enables to determine an occurrence of error by comparing a sensed water level to the first reference value, and a cause of the error occurrence by comparing the sensed water level to the second reference value, and to inform the cause to the user by utilizing that an amount of water held in the tub becomes greater in a case washing water is sprayed non-regularly.

In above description, measures for solving the problem after the user notices the error warning may be change of washing course, or personal removal of the cause (removal or food remnants) or request of after service.

As has been described, the dishwasher, and method for controlling the same of the present invention have the following advantages.

First, non-regular spray of washing water caused by faulty spray nozzle can be made known to the user by sensing a water level during washing, permitting to prevent continuous operation of the dishwasher in a state washing performance is poor, thereby preventing waste of power and drop of user's reliability.

Second, non-regular spray of washing water caused by fall off of the water guide or the like can be made known to the user by sensing a water level during washing, permitting to prevent continuous operation of the dishwasher in a state washing performance is poor, thereby preventing waste of power and drop of user's reliability.

Third, the cause of error occurrence in the case non-regular spray of washing water can be known whether the cause is the spray nozzle or the water guide, to help make taking a measure easy.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A dishwasher having spray nozzles for spraying washing water to wash dishes comprising:
a water level sensing unit for sensing change of a water level of washing water during progressing washing; and
a control unit for determining whether an error is occurred or not in washing water spray according to a water level sensed at the water level sensing unit,
wherein the dishwasher provides a message for warning occurrence of the error in washing water spray to a user.

2. The dishwasher as claimed in claim 1, wherein causes of error occurrence are classified as either stuck of the spray nozzle, or fall off of a water guide which is a washing water circulating passage according to the water level sensed.

3. The dishwasher as claimed in claim 2, wherein the water level sensed at the time of fall off of the water guide which is a circulating passage of the washing water is higher than the water level sensed at the time of stuck of the spray nozzle.

4. The dishwasher as claimed in claim 1, further comprising a display unit for displaying occurrence of the error and a cause of the error, and an alarm generating unit for providing an alarm.

5. The dishwasher as claimed in claim 4, wherein contents of display and kinds of alarm provided are different depending on causes of the error occurrence.

6. The dishwasher as claimed in claim 1, wherein it is determined that the error is occurred in washing water spray if the sensed water level is higher than a preset reference water level.

7. A method for controlling a dishwasher having spray nozzles for spraying washing water to wash dishes, comprising the steps of:
sensing change of a water level of washing water while progressing washing with reference to a preset course;
comparing the water level sensed to a preset reference value to determine whether spray of washing water is regular or not; and
giving a warning to a user if it is determined that the spray of washing water is not regular.

8. The method as claimed in claim 7, wherein the change of a water level of washing water is sensed with reference to a water level of a tub in which the washing water circulated is held.

9. The method as claimed in claim 7, wherein the step of comparing the water level sensed to a preset reference value includes the step of determining that the spray nozzle for spraying washing water is faulty if the sensed water level is higher than the preset reference water level.

10. The method as claimed in claim 7, wherein the step of comparing the water level sensed to a preset reference value includes the step of determining that a water guide which is a circulating flow passage of the washing water is faulty if the sensed water level is higher than the preset reference water level.

11. The method as claimed in claim 7, wherein the step of comparing the water level sensed to a preset reference value includes the steps of;
comparing the sensed water level to a preset first reference value, to determine that the washing water spray is not regular if the sensed water level is higher than the first reference value, and
comparing the sensed water level to a preset second reference value again, to determine a cause of the washing water spray error according to a result of the comparison.

12. The method as claimed in claim 11, wherein the first reference value is higher than the second reference value.

13. The method as claimed in claim 11, wherein the step of comparing the sensed water level to a preset second reference value includes the step of determining that a water guide which is a circulating passage of the washing water is faulty, if the sensed water level is higher than a water level of the second reference value.

14. The method as claimed in claim 11, wherein the step of comparing the sensed water level to a preset second reference value includes the step of determining that the spray nozzle is faulty, if the sensed water level is lower than a water level of the second reference value.

15. The method as claimed in claim 11, wherein depending on causes of the error of the washing water spray, contents of display and kinds of alarm provided for giving a warning to the user are different.
